(19) United States
(12) Patent Application Publication
(10) Pub. No.: US 2022/0194231 A1
(43) Pub. Date: Jun. 23, 2022

(54) REGENERATIVE BRAKING BASED ON A CHARGING CAPABILITY STATUS OF A VEHICLE BATTERY

(71) Applicant: IdeTec GmbH, Rotthalmuenster (DE)

(72) Inventor: Walter KUFNER, Bad Aibling (DE)

(21) Appl. No.: 17/128,324

(22) Filed: Dec. 21, 2020

(51) Int. Cl. B60L 7/14; B60L 15/20

(52) U.S. Cl. CPC B60L 7/14; B60L 15/2009; B60L 2220/12; B60L 2240/54; B60L 2220/14; B60L 2220/18; B60L 2220/42

(57) ABSTRACT

In an electric vehicle electric power generated during a regenerative braking operation performed by one or more first electric machines may partially or entirely be consumed by one or more second electric machines of the electric vehicle. In some illustrative embodiments the one or more second electric machines may be operated in a non-torque mode of operation, thereby avoiding any mechanical interference with the power consuming one or more electric machines that are operated in the regenerative mode of operation.

### BACKGROUND

The present invention generally relates to electric vehicles, in which propelling and at least a portion of braking of the vehicle are accomplished on the basis of electric machines supplied by a chargeable battery system.

There is an ongoing development in the field of transportation for reducing the usage of internal combustion engines and increasingly adopting electric machines. A typical drivetrain of an electric vehicle includes at least one electric machine, an associated machine control unit and a chargeable battery for supplying the required electric power for propelling the electric vehicle.

Due to increasing demands with respect to overall performance, according to recent developments, in many electric vehicles two or more electric machines are implemented in the drivetrain, thereby resulting in increased flexibility in designing respective electric vehicles. One major advantage of electric vehicles is their drivetrains' capability to output negative mechanical power in order to brake or decelerate the electric vehicle. Contrary to internal combustion engines, which may also have the capability of providing controlled negative output power, the negative mechanical output power provided by the drivetrain of an electric vehicle may typically efficiently be converted into electric power, which may then be used for temporarily supplying any electrical loads within the electric vehicle and storing excess electric power in the chargeable battery. This ability of electrical drivetrains in combination with the overall increased efficiency of electric machines compared to internal combustion engines may partially offset the disadvantage of batteries in view of energy density compared to a fuel tank in an internal combustion engine vehicle.

Due to the capability of providing negative mechanical output power by generating electric power that may be supplied to the vehicle internal battery a different driving behaviour may be experienced by the driver of an electric vehicle compared to the driving behaviour of a vehicle with internal combustion engine. For example, in many cases the amount of negative mechanical output power and thus the amount of electric power generated thereby, also referred to herein as regenerative braking or recuperation, may be commanded by the “accelerator” pedal, thereby achieving a so-called “one pedal driving” behaviour. That is, by releasing the accelerator pedal at least one of the electric machines of the drivetrain may produce negative mechanical output power, which results in the controlled conversion of kinetic energy of the vehicle into electric power. Consequently, this capability of regenerative braking may represent an essential part of the overall driving experience and may therefore contribute to an increasing acceptance of electric vehicles over internal combustion engine vehicles. Furthermore, the electric power generated during the regenerative braking not only contributes to reduced overall energy consumption but also reduces overall wear of mechanical components, such as mechanical brake pads, brake discs, and the like.

The performance of the regenerative braking operation is, however, dependent on the capability of the vehicle to “absorb” the electric power generated during the regenerative braking operation. That is, the regenerative braking operation has to be controlled so as to enable the “dissipation” of the electric power, which may preferably be accomplished by controlling the amount of electric power in such a manner that the overall electrical system, including any electrical loads that are active during the regenerative braking operation and in particular the chargeable battery, is capable of accepting the electric power. During a typical regenerative braking operation the amount of electric power to be accepted by the chargeable battery may range from a few hundred watts to several tens of kilowatts, thereby requiring the chargeable battery to be in an appropriate state, in which it is able to be charged with the excess amount of the generated electric power.

It turns out, however, that under certain circumstances the battery's ability of accepting electric power may significantly be reduced, thereby also severely affecting the overall regenerative braking capability of the electric vehicle. For example, when the state of charge of the battery is relatively high or is at approximately 100%, for instance immediately after having charged the battery of the electric vehicle, when driving downhill, and the like, the battery may no longer have the capability of accepting excess electric power generated during the regenerative braking operation. In other cases, the battery status may not allow the charging of the battery or may only allow a charging with a reduced charge current, which may also significantly affect performance of the electric vehicle during a regenerative braking operation. For example, many batteries, such as lithium-based batteries, may require a temperature-dependent charging strategy. That is, such batteries must not be charged below a certain critical temperature, or in other cases the charging capability is significantly reduced at low temperatures.

Electric power generated during a regenerative braking operation may be dissipated by additional measures, such as providing a break “resistor”, which is used for converting the electric power into heat. In other approaches, the battery status with respect to charging capability is taken into consideration upon performing a regenerative braking operation by reducing the braking effect of the one or more electric machines so as to comply with the amount of electric power that may be supplied to the battery at its momentary status.

Although the conventional techniques may basically allow regenerative braking, the former approach requires additional components in order to effectively dissipate the electric power as waste heat, while the latter approach has a significant effect on the braking performance of the electric vehicle. That is, the latter approach does not provide for a consistent regenerative braking experience for a driver.

It is an object of the present invention to provide a consistent regenerative braking behaviour while avoiding or at least reducing the effects of one or more of the problems identified above.

### SUMMARY

Basically, the present invention is based on the concept that a negative mechanical output power of a drivetrain may be obtained on the basis of regenerative braking, wherein at least one of the electric machines in the drivetrain of an electric vehicle may be used to “dissipate” any excess electric power generated during the braking operation by one or more of other electric machines of the drivetrain. Consequently, at least one electric machine may be used as a power dissipation unit, thereby avoiding any additional hardware components, such as specifically designed dissipation resistors and an associated adaptation of the vehicle internal cooling system, and the like. In advantageous embodiments, the one or more electric machines used for electric power consumption may be operated such that the overall braking performance of the drivetrain may be substantially not affected. To this end, the at least one electric machine may be operated in a zero-torque or non-torque mode of operation so as to consume power, substantially without mechanically interacting with the remainder of the drivetrain.

One illustrative embodiment of the present invention relates to an electric vehicle. The electric vehicle includes a drivetrain including a first electric machine and a second electric machine, wherein the drivetrain is configured to selectively provide positive mechanical output power for propelling and negative mechanical output power for braking of the electric vehicle. Moreover, the electric vehicle includes a machine control unit that is electrically connected to the first and second electric machines and is configured to control the first and second electric machines so as to selectively provide positive mechanical output power and negative mechanical output power. Furthermore, the electric vehicle includes a rechargeable battery that is electrically connected to the machine control unit. Moreover, the electric vehicle includes a recuperation controller that is electrically connected to the machine control unit. The recuperation controller is configured to obtain a momentary charging capability status of the battery, to obtain a brake command indicating an amount of the negative mechanical output power to be provided by the drivetrain and to cause the machine control unit to operate the first electric machine so as to perform a regenerative braking operation. Moreover, the recuperation controller is configured to cause the machine control unit to operate the second electric machine so as to consume electric power based on the momentary charging capability status.

A still further illustrative embodiment of the present invention relates to a recuperation controller for an electric vehicle. The recuperation controller includes a connection arrangement configured to enable an electrical connection to a machine control unit that is configured to operate two or more electric machines of a drivetrain of the electric vehicle. The recuperation controller further includes a first input that is configured to receive a signal indicative of a momentary charging capability of a chargeable battery of the electric vehicle. The recuperation controller further includes a second input that is configured to receive a brake command indicating a required amount of negative mechanical output power to be provided by the drivetrain. Furthermore, the recuperation controller includes a determination unit that is configured to generate at least one command signal for the machine control unit so as to cause the machine control unit to operate the first electric machine so as to perform a regenerative braking operation and cause the machine control unit to operate the second electric machine so as to consume electric power based on the momentary charging capability status.

A still further illustrative embodiment of the present invention relates to a method of controlling regenerative braking of an electric vehicle. The method includes obtaining a momentary charging capability status of a chargeable battery of the electric vehicle. The method further includes obtaining a brake command indicating a required amount of negative mechanical output power to be provided by a drivetrain of the electric vehicle. Moreover, the method includes operating a first electric machine of the drivetrain so as to perform a regenerative braking operation. Additionally, the method comprises operating a second electric machine of the drivetrain so as to consume electric power based on the momentary charging capability status.

### BRIEF DESCRIPTION OF THE DRAWINGS

Further illustrative embodiments are described in the following detailed description while also referring to the accompanying drawings, in which

FIG. 1 schematically illustrates an electric vehicle including a drivetrain having at least a first electric motor and a second electric motor, at least one of which is to be controlled so as to temporarily operate in zero-torque state according to illustrative embodiments;

FIG. 2 schematically illustrates a zero-torque state for a reluctance type electric machine according to illustrative embodiments; and

FIG. 3 illustrates a flowchart representing actions for consuming electric power during a regenerative braking operation according to still other illustrative embodiments of the present invention.

### DETAILED DESCRIPTION OF EXEMPLARY EMBODIMENTS

Generally, the present invention is based on the concept that a regenerative braking operation may be applied in an electric vehicle irrespective of the momentary charging capability of the battery of the electric vehicle, i.e., irrespective of whether only storage of a certain amount of electric energy in the vehicle battery or no storage at all is allowed at a given time. To this end, it has been recognised that at least one electric machine of the electric vehicle's drivetrain may be operated in a mode of operation, in which electric power is consumed in a controlled manner, while at least one further electric machine may generate electric power during regenerative braking in accordance with circumstances, for instance as dictated by driving requirements, and the like.

In some embodiments the power consumption of the one or more electric machines that are operated to remove any “excess” electric power during the regenerative braking may be controlled so as to substantially not contribute to the overall mechanical output power of the drivetrain, thereby enabling a desired or typical braking behaviour of the electric vehicle, irrespective of the charging capability of the battery system. This specific mode of operation of the one or more electric machines may be referred to herein as zero-torque state or mode or non-torque mode or state in order to indicate a substantially torque-less operation of the one or more electric machines, while still consuming a desired amount of electric power.

Furthermore, a zero-torque state or non-torque state is to be understood as any state of the electric machine, in which a rotating magnetic field is generated in the stator of the electric machine, while the resulting mechanical output power and thus output torque is approximately 1% of the rated mechanical output power or output torque or significantly less. For example, if an electric machine has a rated output torque of 100 Nm (Newton×meter), a non-torque state or zero-torque state is to be understood as the state or mode of operation, in which the mechanical output torque is upon 1 Nm or less. A respective non-torque mode of operation may be implemented in many types of electric machines, such as asynchronous machines, synchronous machines with permanent magnets, synchronous machines with external excitation, reluctance type machines or a combination of synchronous type machines and reluctance type machines, brushless DC motors, and the like.

For example, for an asynchronous electric machine controlling the magnetic field generated by the stator windings in such a way that the resulting magnetic field is synchronous with the rotor, will result in substantially zero output torque of the asynchronous machine, while the power consumption may be controlled by controlling the excitation current required for generating the rotating magnetic field. Similarly, for a synchronous machine the rotating magnetic field may be controlled so as to remain aligned with the rotor with a phase angle of approximately zero between rotating magnetic field and a magnetically preferred direction of the rotor, thereby also causing substantially no output torque, while still allowing consumption of electric power by varying the magnetisation of the stator windings. Also, in a reluctance type machine, the phase angle between the magnetically preferred direction of the rotor and the rotating magnetic field may be kept at substantially zero, thereby also avoiding output of mechanical torque, while still allowing the power consumption of the electric reluctance type machine to be varied.

Consequently, upon determining the momentary charging capability status of the battery of the electric vehicle a certain amount or all of the electric power generated during a regenerative operation by one or more electric machines may be consumed and thus dissipated by one or more other electric machines, which in some embodiments may even be accomplished substantially without mechanically interfering with the regenerative braking operation.

In illustrative embodiments a recuperation controller is configured to be connectable to a machine control unit, which controls at least a first electric machine and a second electric machine. The recuperation controller may initiate a control operation such that substantially the entire amount of a negative mechanical output power may be provided by the first electric machine. That is, upon a request for providing negative mechanical output power at a drivetrain of the electric vehicle a respective appropriate control sequence may be applied to the at least one first electric machine in order to obtain the required braking force, i.e. the entire requested negative mechanical output power is provided by the one or more regenerating electric machines. For example, in some illustrative embodiments, the requested braking power may cover a wide range of typical negative mechanical output powers encountered during a wide range of driving conditions so that a specific driving experience may be associated with the available range of negative mechanical output power. Consequently, in some illustrative embodiments, this negative mechanical output power may be provided in a typical manner in accordance with the driver's regenerative braking experience without being affected by the charging capability status of the battery, since any desired fraction of the electric power generated by the negative mechanical output power may be “dissipated” by the one or more second electric machines.

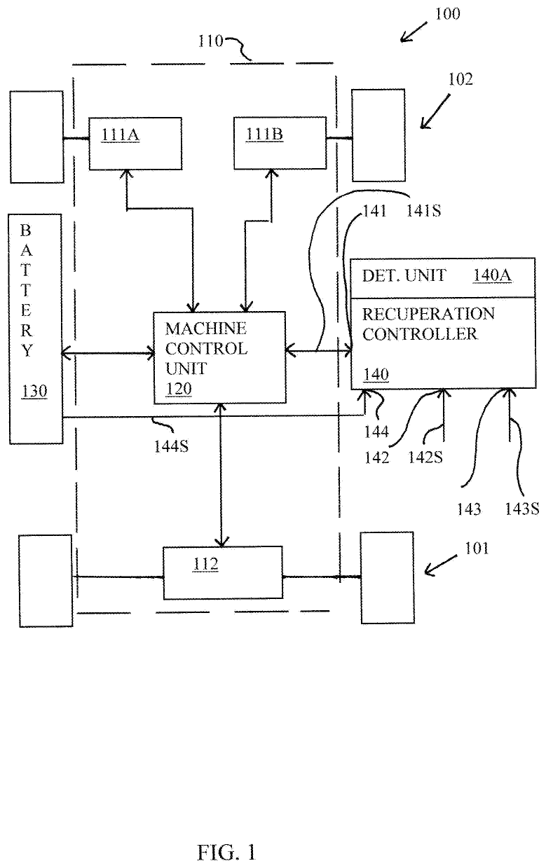

FIG. 1 schematically illustrates an electric vehicle 100 according to illustrative embodiments of the present invention. The electric vehicle 100 includes a drivetrain 110 that is appropriately configured so as to propel the electric vehicle 100 and also to perform a regenerative braking operation, if required. To this end, the drivetrain 110 is appropriately mechanically coupled to one or more axles 102 and 101, wherein each of the axles 102, 101 may include at least one wheel. For example, if the electric vehicle 100 is to represent a typical passenger car a front axle, such as the axle 101, and a rear axle, such as the axle 102, may be provided, each including two wheels. In other cases, one or both of the axles 101, 102 may include only one wheel, as in the case of a motorcycle, or any three-wheeled vehicle, and the like. In still other cases, one or both of the axles 101, 102 include more than one wheel. The drivetrain 110 is to be considered to encompass any type of electrically powered vehicle, such as cars, motorcycles, three-wheelers, trucks, vans and the like. Moreover, in the herein used sense the term drivetrain does not include a mechanical brake system. Such a mechanical brake system is to be considered a component or system that is separate to the drivetrain 110.

It should be appreciated that for convenience any known mechanical components for mechanically coupling the drivetrain 110 to the axles 101, 102 are not shown, as any such components are well established in the art. The drivetrain 110 may include at least one electric machine 112, which may appropriately be mechanically coupled to the axle 101, for instance, by a differential gear unit (not shown), and the like. In still other cases (not shown) one further electric machine may be provided in addition to electric machine 112 so as to be coupled to the axle 101. For example, when two electric machines are provided for the axle 101, each of the respective wheels may mechanically be coupled to a respective one of the two electric machines.

Similarly, the drivetrain 110 may include at least one further electric machine 111A, which is appropriately mechanically coupled to the axle 102. In the example shown, a further electric machine 111B may be provided so as to engage with the axle 102. For convenience, any appropriate mechanical gear unit for coupling the electric machines 111A, 111B to the axle 102 are not shown, however, any such components are well established in the art. Moreover, it is to be noted that any other components that may be required for operating the electric vehicle 100 are, for convenience, not shown in FIG. 1. For example, one or both of the axles 101, 102 may appropriately be equipped with a steering system.

The electric machines 112, 111A, 111B of the drivetrain 110 may be connected to a machine control unit 120, which may be understood as a component that provides appropriate electric power to the electric machines 112, 111A, 111B as is required for achieving the desired mode of operation of the drivetrain 110. For example, the machine control unit 120 may include respective inverters, which may, on the basis of appropriate control signals, provide appropriately configured electric power, for instance in the form of current and voltage pulses, and the like, thereby converting electric power from a chargeable battery 130 into electric output power for the electric machines, and vice versa when one or more of the electric machines is operated as a generator during a regenerative braking operation. In other cases, a single inverter may be used for two or more electric machines, if a required mode of operation may be achieved on the basis of a single inverter.

Consequently, the machine control unit 120 may appropriately be configured so as to operate the electric machines 112, 111A, 111B on the basis of appropriate voltage and current signals, which may depend on the driving state of the vehicle 100, the type of electric machines used in the drivetrain 110, and the like. For example, if the electric machine 112 is provided in the form of an asynchronous electric machine, appropriate control mechanisms may be implemented in the machine control unit 120, for instance based on simple voltage/frequency control algorithms, voltage vector control algorithms, and the like, in order to provide the required voltage and current signals so as to operate the asynchronous machine with high efficiency. Similarly, when the electric machine 112 is provided in the form of a permanent magnet synchronous machine the machine control unit 120 may provide appropriate voltage and current signals so as to obtain a desired mode of operation of the electric machine. Similarly, when the electric machine 112 is provided in the form of reluctance machine or a combination of a synchronous machine and a reluctance machine, appropriate control mechanisms may be implemented in the machine control unit 120 in order to provide the voltage and current signals for obtaining the desired mode of operation of the electric machine 112.

The above criteria discussed with respect to the electric machine 112 also apply to the electric machine 111A and, if provided, to the electric machine 111B.

It should be appreciated that typically the drivetrain 110 in combination with the machine control unit 120 is appropriately configured so as to provide positive mechanical output power at one or both of the axles 101, 102, when propelling of the vehicle 100 is required. On the other hand, the drivetrain 110 may provide negative mechanical output power at one or both of the axles 101, 102, if a braking of the vehicle 100 is required.

It should be noted that the term “braking” is to include any situation and circumstances, in which the negative mechanical output power provided by the drivetrain 110 may result in the generation of electric power in at least one of the electric machines of the drivetrain 110 by converting kinetic energy of the vehicle into electric energy, irrespective of whether the speed of the vehicle 100 varies during the braking operation. Respective modes of operation of one or more electric machines for performing a “regenerative” braking operation, i.e. providing negative mechanical output power and thus a braking torque at least at one of the axles 101, 102, is well established in the art and respective control algorithms may not be described herein in detail.

The electric vehicle 100 further includes a recuperation controller 140, which may be connected to the machine control unit 120 by a connection arrangement 141 so as to obtain information with respect to the status of any of the electric machines 112, 111A, 111B and also so as to transmit a control signal or command 141S to the machine control unit 120. In other cases the machine control unit 120 and the recuperation controller 140, or a portion thereof, may be an integrated functional block of hardware and/or software. The control signal 141S or command may include any type of information and may have any format in order to enable the machine control unit 120 to generate appropriate voltage and current signals for the electric machines 112, 111A, 111B.

The recuperation controller 140 may have a first input 144 to receive a signal 144S from the battery 130, wherein the signal 144S may indicate a momentary charging capability status of the battery 130 or the signal 144S may include information that allows the charging capability status to be derived. It should be appreciated that a typical battery of an electric vehicle includes a battery management system (not shown), which monitors and controls the operation of the battery. In some embodiments, the battery 130 may include a battery management system (not shown), which may be configured to output the charging capability status of the battery 130 at any given point in time. The charging capability status, in turn, may be based on the state of charge (SOC) of the battery 130, the state of health (SOH) of the battery 130, the temperature of the battery 130, or the like. Therefore, the charging capability status may indicate the battery's capability of receiving electric power at any given point in time and may therefore indicate the amount of electric power that the battery 130 is able to receive at a given point in time.

For example, when the SOC of the battery 130 is at approximately 100% the charging capability status may indicate that the battery 130 is not able to receive electric power. Similarly, if any battery parameter, such as the internal battery temperature of one or more battery cells, which may be included in the battery 130, is in a range, in which the capability of receiving electric power is reduced or non-existent, the charging capability status, for example represented by the signal 144S, may indicate that at this point in time the battery 130 may receive only a restricted amount of electric power or may not receive electric power at all.

The recuperation controller 140 may further include a second input 143 for receiving a signal 143S that may represent a command for instructing the drivetrain 110 to output a negative mechanical output power in order to perform a braking operation. The command signal 143S may be generated by an appropriate input/output device, such as an accelerator pedal, a brake pedal, respective switches or the like, which may be operated by a human operator of the vehicle 100, and/or the command or signal 143S may be generated by supervising control system (not shown), when the vehicle 100 is in some sort of autonomous or semi-autonomous mode of operation.

Furthermore, the recuperation controller 140 may further include a third input 142 for receiving signals 142S, which may represent the status of other components of the electric vehicle 100. For example, the one or more signals 142S may represent the status of components of the vehicle 100, such as heating/cooling components, lighting, rotation speed of wheels, and the like, thereby, among others, providing information to the recuperation controller 140 with respect to the total amount of electric power consumed at any given moment.

When operating the vehicle 100 in a positive output power mode, that is, when propelling the vehicle 100, any load in the vehicle 100 may receive electric power from the battery 130, and also the control unit 120 may also receive electric power from the battery 130 and may appropriately convert the electric power, typically a DC (direct current) power from the battery 130 into an appropriate AC (alternating current) type of power for at least one of the electric machines 112, 111A, 111B. The recuperation controller 140 may monitor the charging capability status, for example represented by the signal 144S, of the battery 130 so as to have knowledge at any given point in time whether the battery 130 would be able to receive electric power.

When the signal or command 143S indicates a request for a negative mechanical output power of the drivetrain 110 that is, a regenerative braking operation is instructed by the signal 143S, the recuperation controller 140 is appropriately configured, for instance by having implemented therein a determination unit 140A, to estimate, on the basis of the momentary charging capability status, for instance represented by the signal 144S, of the battery 130, whether or not the battery 130 is capable of receiving electric power. If the battery 130 is able to receive electric power, the recuperation controller 140 or the determination unit 140A thereof is also configured to determine a momentary amount of electrical power that the battery 130 would be able to receive. Consequently, based on the negative mechanical output power requested to be generated during the regenerative braking operation and based on the overall electric power consumption in the vehicle 100, for example indicated by or derivable from the signal 142S, the recuperation controller 140 may estimate the residual amount of electric power that may have to be “dissipated”, if the charging capability status, as for instance represented by the signal 144S, indicates that the battery 130 may not receive the entire excess electric power during the regenerative braking operation. In this case, the recuperation controller 140 or the determination unit 140A thereof is configured to provide the control signal or command 141S so as to cause the machine control unit 120 to operate at least one of the electric machines 112, 111A, 111B of the drivetrain 110 to consume excess electric power.

In one illustrative embodiment, the recuperation controller 140 is appropriately configured, for instance by having implemented therein or in the determination unit 140A a process flow, as will be described later on, to cause one or more electric machines of the drivetrain 110 to be operated so as to consume the excess electrical power, substantially without mechanically interfering with the one or more electric machines that provide the negative mechanical output power. To this end, the one or more electric machines to be operated to consume electric power may be operated in a zero-torque state or non-torque state during the regenerative braking operation. Assuming that the machine 111A may produce electric power and thus performing a regenerative braking operation, one or both of the machines 111B and 112 may consume excess electric power in a non-torque state. Similarly, when the machine 111B is to produce electric power, one or both of the machines 111A and 112 may consume excess electric power in a non-torque state. Also, when the machine 112 is to produce electric power, one or both of the machines 111A and 111B may consume excess electric power in a non-torque state. It is to be noted that any combination of electric machines may be used for producing electric power and consume excess electric power as long as the drivetrain 110 includes at least two electric machines.

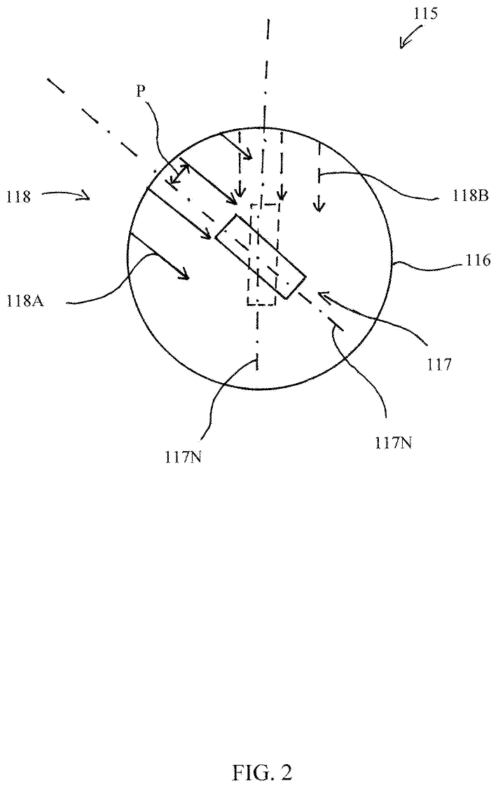

FIG. 2 schematically illustrates an electric machine 115, which may represent any one of the electric machines 111A, 111B, 112 of the drivetrain 110 in FIG. 1. The electric machine 115 includes a stator 116, which is illustrated in a very schematic manner and which typically includes respective windings (not shown) that may appropriately be connected to the machine control unit 120. Hence, the stator 116 and the control unit 120 may exchange appropriate voltage and current signals in order to establish a respective magnetic field 118, which is typically a rotating magnetic field, as indicated by magnetic fields 118A and 118B representing the magnetic field 118 at two different points in time. Moreover, the electric machine 115 comprises a rotor 117, which may be a rotor of an asynchronous machine, a rotor including permanent magnets, for instance as in a brushless DC motor or a synchronous machine, and the like, or may be the rotor of a reluctance type machine. For a synchronous machine, a DC brushless machine or a reluctance type machine, the rotor 117 may have a preferred magnetic direction 117N, for instance, caused by the arrangement of permanent magnets, a configuration of asymmetric magnetic reluctance, and the like.

For example, when the rotor 117 represents the rotor of an asynchronous machine, the rotating magnetic field 118 generated by the stator 116 may be controlled such that the rotor 117 appears to be static with respect to the rotating magnetic field 118. Consequently, no voltage is induced in the rotor 117 by respective rotor windings and therefore no current will flow in the rotor windings and thus the rotor 117 does not produce any output torque.

Similarly, when the rotor 117 is to represent the rotor of a reluctance type of machine, the rotating magnetic field 118 is controlled so as to be substantially aligned with the direction 117N, i.e., the direction of minimum reluctance of the rotor 117. In this case the external magnetic field 118 and the magnetically preferred direction 117N are parallel so that a corresponding angle, also referred to herein as phase angle P, between the direction 117N and the external magnetic field 118 remains substantially zero at any given time during the non-torque state. For example, the positional relation between the magnetic field 118 and the rotor 117, i.e. its direction 117N of minimum reluctance, is illustrated for two situations. In a first position the rotor 117, indicated by solid lines, is aligned with the magnetic field 118, indicated by solid lines and referred to as field 118A. The direction 117N in this point in time is parallel to the field 118A. Furthermore, the rotor 117 may rotate, for instance caused by an external torque applied to electric machine 115 by respective components of the drivetrain 110, such as wheels, gear units, and the like, (cf. FIG. 1), as indicated by the rotor 117 shown by dashed lines, and also the magnetic field has rotated by the same amount, as indicated by the field 118B, also shown in dashed lines. Therefore, the direction 117N at this point in time is parallel to the field 118B. It should be appreciated that during any intermediate position, the magnetic field 118 is controlled so as to remain aligned with respect to the rotor 117, i.e., the direction 117N remains parallel to the field 118. Consequently, no or substantially no torque is produced by the rotor 117 that may act against the externally applied torque.

The same situation holds true for a permanent magnet synchronous machine or a brushless DC motor, wherein the rotating magnetic field 118 may be controlled so as to follow the rotation of the rotor 117 at a zero phase angle P.

Therefore, the machine 115 when operated in the non-torque state as discussed above may not interfere with the mechanical status of the drivetrain 110.

It should be appreciated that in the context of this application a slight misalignment between the magnetic field 118 and the rotor 117 of the corresponding electric machine 115, or a slight difference in rotational speed of the rotor and the electric field in the case of asynchronous machine, may still occur and may result in a certain small torque, wherein, however, a non-torque or zero-torque state is to be understood as any state, in which a possibly resulting torque is 1% or less of the rated torque of the electric machine 115 under consideration. In illustrative embodiments, any torque potentially induced in a non-torque state is less than 0.5 percent of the rated torque of the electric machine 115 under consideration.

By varying the voltage supplied to the electric machine 115 while adjusting the frequency of the voltage so as maintain synchronicity between rotor and magnetic stator field of an asynchronous machine or maintain the phase angle P at zero for a synchronous machine or a reluctance machine during a corresponding non-torque mode of operation, the magnetisation current of the electric machine 115 and thus the power consumption may appropriately be varied so as to adjust the power consumption to a specified desired amount. That is, the recuperation controller 140, based on input signals, such as the signal 142S indicating the speed of the rotor 117, may cause the machine control unit 120 to output voltage or current signals to the machine 115 so that the magnetic field 118 and the rotor rotate with basically the same speed, as is typically the case for synchronous and reluctance type electric machines, and the respective phase angle is adjusted to zero. For an asynchronous machine the speed of the magnetic field 118 is adjusted to the speed of the rotor 117, thereby nullifying the relative motion between the rotor 117 and the field 118 and also resulting in zero or substantially zero torque. For example, the one or more signal 142S may include information with respect to the momentary angular position of the rotor 117, which in turn may be used to estimate the momentary angular orientation of the field 118.

It should be appreciated that typically electric machines of the drivetrain 110, such as the machines 111A, 111B, 112 are integrated in an appropriate heating/cooling system (not shown), so that any additional heat generated during the non-torque mode of operation may efficiently be dissipated and may, for instance, efficiently be redirected for heating the battery 130, if required. In other cases, the respective heat may efficiently be dissipated to the outside of the vehicle 100.

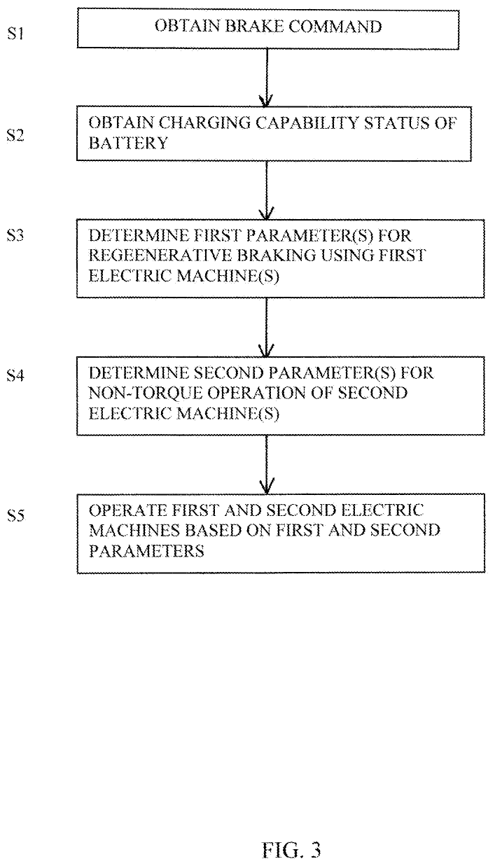

With reference to FIG. 3 a respective method of controlling the regenerative braking of an electric vehicle will be discussed in more detail.

In a step S1 a brake command may be obtained, for instance via the command signal 143S and the respective command signal may be triggered by any appropriate device, such as an accelerator pedal, a brake pedal, switches, and autonomous control algorithm, and the like. In illustrative embodiments, when obtaining the brake command the recuperation controller 140 may also obtain other vehicle relevant information, such as vehicle speed, rotational speed of one or more components of the drivetrain 110, such as rotational speed of one or more of the electric machines 111A, 111B, 112, of one or more of the wheels connected to axles 101 and 102, the voltage of the battery 130, a current input in and output from the battery 130, and the like. Therefore, in some illustrative embodiments, at least the overall power consumption of the vehicle 100 may be known at the time, at which a regenerative braking operation is requested.

In a step S2 the charging capability status of the battery 130 is obtained, for instance based on the signal 144S. As previously discussed, the charging capability status may indicate the ability or capability of the battery 130 to receive electric power under the momentary circumstances. To this end, the charging capability status of the battery 130 may be determined on the basis of specific battery parameters, such as state of charge, state of health, internal battery temperature, type of battery cells used in the battery 130, and the like. It should be appreciated that the actual charging capability status may be output by the battery 130 itself, i.e. the respective battery management system (not shown), or a respective component, such as the recuperation controller 140 or its determination unit 140A, may determine the charging capability status on the basis respective battery parameters, as discussed above. Consequently, when referring to “obtaining the charging capability status of the battery” by the recuperation controller 140 this is meant to also include a process, in which the charging capability status of the battery is determined in the recuperation controller 140 or the determination unit 140A.

In step S3 one or more first parameters may be determined for a regenerative braking operation of a first electric machine based on the brake command. For example, the first electric machine may be one or both of the electric machines 111A, 111B or may be the electric machine 112, possibly in combination with one of the machines 111A and 111B, depending on the overall concept of the electric vehicle 100. For example, electric machine 111A, if a single electric machine is provided at the axle 102, may be selected as the regenerating electric machine and may thus appropriately be controlled so as to provide negative mechanical output power via the drivetrain 110, that is, the electric machine 111A is operated as a generator. In other cases, when the two electric machines 111A, 111B are provided, both machines may be used for conducting the regenerative braking operation.

In other cases, the electric machine 112, possibly in combination with one of the machines 111A and 111B, may be operated so as to provide the negative mechanical output power for the drivetrain 110 and may thus act as the first electric machine. In this case, one or both of the electric machines 111A, 111B may be available for consuming excess electric power produced during the regenerative braking operation.

In step S4 one or more second parameters may be determined for a non-torque mode of operation of one or more second electric machines based on the charging capability status obtained in step S2. Thus, any of the electric machines 111A, 111B, 112 that is not used for the braking operation may be used as the second electric machine. The one or more second parameters may therefore indicate control information to be used for operating the second electric machine(s) so as to transit into a non-torque mode of operation. As discussed above, one or more second parameters may therefore convey respective information to the machine control unit 120 in order to operate the second electric machine in the desired non-torque mode, as for example discussed above in the context of FIG. 2. Furthermore, the one or more second parameters may continuously be updated in order to appropriately reflect the amount of electrical power that is to be consumed at any given point in time.

In step S5 the first and second electric machines may be operated on the basis of the one or more first parameters and the one or more second parameters so that a certain desired balance may be accomplished between electric power generated during the regenerative braking of the one or more first electric machines and the power consumption of the one or more second electric machines. It should be appreciated that the appropriate balance between regeneratively produced electric power and power consumed by the one or more electric machines operated in the non-torque mode may dynamically be adapted based on information obtained by the recuperation controller 140.

For example, the amount of current flowing into or out of the battery 130 may dynamically be determined, and the amount of power consumption in the one or more electric machines operated in the power consumption mode, for instance in the non-torque state, may be adapted on the basis of the dynamically determined current flow. For instance, in some illustrative embodiments, the expected electric power produced by the regenerative braking operation at an initial phase may be estimated and may be compared to the power consumption of any other electric component in the vehicle 100 in order to obtain a predicted or estimated amount of electric power to be consumed by the one or more second electric machines so as to obtain the desired power flow in the electric vehicle 100, while also taking into consideration the charging capability status of the battery 130.

As an example, if a power flow into the battery 130 is prohibited due to a certain status of the battery, for instance the state of charge is at or near 100%, the internal temperature of the battery does not allow charging of the battery, and the like, the second electric machine may be controlled under the control of the recuperation controller 140, so as to safely avoid a flow of current into the battery 130. For example, the initial power consumption may be adjusted so that even a minor amount of current may be drawn from the battery 130 and a corresponding balance may be obtained during the further progression of the regenerative braking operation. In other cases, when an uncertainty with respect to the balance between regeneratively produced electric power and the power consumption of non-torque operation of the second electric machine(s) may be taken into consideration, an electric load, such as the heating system in the vehicle 100, may be activated prior to or at the beginning of the regenerative braking operation, thereby providing for a certain margin for minor control errors. Thereafter, during the further progression of the regenerative braking operation a respective balancing with a desired degree of accuracy may be accomplished without requiring the continued activation of the additional electric load.

In other cases, when the charging capability status of the battery 130 indicates that a certain amount of electric power may be received by the battery 130 at a given point in time, the power consumption and/or the power generation during the regenerative braking operation may appropriately be controlled so as to remain safely below the limit for the maximum current that is allowed to flow into the battery 130.

As a result, the systems and methods disclosed herein may provide for the possibility of performing a regenerative braking operation of an electric vehicle, substantially without being constrained by the status of the vehicle battery. That is, the electric vehicle exhibits a driving behaviour with respect to regenerative braking that is independent of the battery's capability of receiving electric power at a given moment in time. For instance, in many cases, lithium-based batteries may be used, in which the charging at lower temperatures is restricted or prohibited and therefore regenerative braking may not be allowed or may be allowed only partially, as long as the battery internal temperature remains below a certain value. Therefore, the driving behaviour may significantly differ from the driving behaviour when the regenerative braking capability is fully available. In this respect, the present invention provides for the possibility of substantially maintaining a typical driving behaviour, irrespective of the battery internal temperature and/or the state of charge, and/or other battery related parameters that may influence the charging capability of the battery. The excess electric power may be reliably consumed by one or more of the electric machines during the regenerative braking operation performed by one or more other electric machines, in some embodiments, substantially without affecting the mechanical response of the drivetrain. The excess power consumption may be taken advantage of for increasing the speed of reaching an appropriate temperature of an initially cold battery by allowing “dissipation” of the excess electric power in the form of heat, for instance via the heating/cooling system of the electric vehicle, and by redirecting more heat to the battery, if the heating/cooling system is correspondingly configured.

Similarly, the state of charge may not allow a charging of the battery or may allow only a restricted amount of current to flow into the battery. Also in this case, the controlled power consumption of the one or more second electric machines may nevertheless enable a regenerative braking operation so as to allow for a substantially consistent driving behaviour. For example, a one-pedal driving may be preserved irrespective of the status of the battery.

In many cases the maximum electric power generated during a regenerative braking operation is limited to a certain amount, so that in most situations the power consumption effected by one or more of the electric machines may suffice for dissipating any excess power and, thus, result in a consistent driving experience.

It should be appreciated that the functions discussed herein may be implemented by software and/or hardware. For example, a portion of the recuperation controller 140 may be part of a conventional controller of an electric vehicle and the functions discussed herein may be implemented by the determination unit 140A. In other cases the functions discussed above may be implemented in the form of one or more software modules. For example, the determination unit 140A may be provided in the form of software module within a conventional control unit of an electric vehicle. Moreover, the recuperation controller 140 may be provided as a stand alone unit to be retrofitted into existing electric vehicles or to be mounted in new electric vehicles.

The terms “a” or “an” are used to refer to one, or more than one feature described thereby. Furthermore, the term “coupled” or “connected” refers to features which are in communication with each other (electrically, mechanically, thermally, as the case may be), either directly, or via one or more intervening structures or substances. The sequence of operations and actions referred to in method flowcharts are exemplary, and the operations and actions may be conducted in a different sequence, as well as two or more of the operations and actions conducted concurrently. Reference indicia (if any) included in the claims serve to refer to one exemplary embodiment of a claimed feature, and the claimed feature is not limited to the particular embodiment referred to by the reference indicia. The scope of the claimed feature shall be that defined by the claim wording as if the reference indicia were absent therefrom. All publications, patents, and other documents referred to herein are incorporated by reference in their entirety. To the extent of any inconsistent usage between any such incorporated document and this document, usage in this document shall control.

As readily appreciated by those skilled in the art, the described processes and operations may be implemented in hardware, software, firmware or a combination of these implementations as appropriate. In addition, some or all of the described processes and operations may be implemented as computer readable instruction code resident on a computer readable medium, the instruction code operable to control a computer of other such programmable device to carry out the intended functions. The computer readable medium on which the instruction code resides may take various forms, for example, a removable disk, volatile or non-volatile memory, etc.

The foregoing exemplary embodiments of the invention have been described in sufficient detail to enable one skilled in the art to practice the invention, and it is to be understood that the embodiments may be combined. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined solely by the claims appended hereto.

1. An electric vehicle, comprising
a drive train including a first electric machine and a second electric machine, said drive train being configured to selectively provide positive mechanical output power for propelling said electric vehicle and negative mechanical output power for braking of said electric vehicle;
a machine control unit electrically connected to said first and second electric machines and configured to control said first and second electric machines so as to selectively provide said positive mechanical output power and said negative mechanical output power;
a chargeable battery electrically connected to said machine control unit; and
a recuperation controller electrically connected to said machine control unit and configured to obtain a momentary charging capability status of said battery,
obtain a brake command indicating an amount of said negative mechanical output power to be provided by said drive train,
cause said machine control unit to operate said first electric machine so as to perform a regenerative braking operation and
cause said machine control unit to operate said second electric machine so as to consume electric power based on said momentary charging capability status.

2. The electric vehicle of claim 1, wherein said recuperation controller is further configured to cause said machine control unit to operate said first electric machine so as to substantially provide said amount of said negative mechanical output power.

3. The electric vehicle of claim 1, wherein said recuperation controller is further configured to cause said machine control unit to operate said second electric machine in a substantially non-torque mode.

4. The electric vehicle of claim 3, wherein said second electric machine is an asynchronous machine and said non-torque mode corresponds to a mode, in which the asynchronous machine is operated in synchronous mode.

5. The electric vehicle of claim 3, wherein said second electric machine is at least one of a synchronous-type machine, a reluctance type machine and a combination thereof and said non-torque mode corresponds to a mode, in which a phase angle between a rotor of the second electric machine and a rotating magnetic field is kept at approximately zero.

6. The electric vehicle of claim 1, wherein said drive train includes, in addition to said first electric machine and said second electric machine, at least one further electric machine.

7. A recuperation controller for an electric vehicle, comprising
a connection arrangement configured to enable an electrical connection to a machine control unit that is configured to operate two or more electric machines of a drive train of said electric vehicle;
a first input configured to receive a signal indicative of a momentary charging capability of a chargeable battery of said electric vehicle;
a second input configured to receive a brake command indicating a required amount of negative mechanical output power to be provided by said drive train; and
a determination unit configured to generate at least one command signal for said machine control unit so as to cause said machine control unit to operate said first electric machine so as to perform a regenerative braking operation and cause said machine control unit to operate said second electric machine so as to consume electric power based on said momentary charging capability status.

8. The recuperation controller of claim 7, wherein said determination unit is configured to cause said machine control unit to operate said first electric machine so as to substantially provide said required amount of negative mechanical output power.

9. The recuperation controller of claim 7, wherein said determination unit is configured to cause said machine control unit to operate said second electric machine in a substantially non-torque mode.

10. A method of controlling regenerative braking of an electric vehicle, the method comprising
obtaining a momentary charging capability status of a chargeable battery of said electric vehicle;
obtaining a brake command indicating a required amount of negative mechanical output power to be provided by a drive train of said electric vehicle;
operating a first electric machine of said drive train so as to perform a regenerative braking operation and
operating a second electric machine of said drive train so as to consume electric power based on said momentary charging capability status.

11. The method of claim 10, wherein operating said first electric machine comprises operating said first electric machine so as to provide said required amount of negative mechanical output power.

12. The method of claim 10, wherein operating said second electric machine comprises operating said second electric machine in a substantially non-torque mode.

13. The method of claim 12, wherein said second electric machine is an asynchronous machine and said non-torque mode corresponds to a mode, in which the asynchronous machine is operated in synchronous mode.

14. The method of claim 12, wherein said second electric machine is at least one of a synchronous-type machine, a reluctance type machine and a combination thereof and said non-torque mode corresponds to a mode, in which a phase angle between a rotor of the second electric machine and a rotating magnetic field is kept at approximately zero.
